(19) United States
(12) Patent Application Publication
(10) Pub. No.: US 2025/0165227 A1
(43) Pub. Date: May 22, 2025

(54) Protecting Software

(71) Applicant: Promon AS, Oslo (NO)

(72) Inventors: Andrew Whaley, Buxton (GB); lan Sidor, Whiston (GB)

(21) Appl. No.: 18/839,090

(22) PCT Filed: Feb. 16, 2023
(86) PCT No.: PCT/EP2023/053984

§ 371 Date: Aug. 16, 2024

(30) Foreign Application Priority Data
Feb. 18, 2022 (GB) 2202209.9

(51) Int. Cl. G06F 8/30

(52) U.S. Cl. CPC G06F 8/30

(57) ABSTRACT

Methods and systems for generating a secured software application (108) involve receiving a source software application (100); identifying one or more sets of source instructions (102) within it and for each of the sets of source instructions (102) generating data (106) representative of the set of source instructions. A secured software application (108) is generated having the data (106) and a runtime engine (114). The runtime engine (114) has code for processing the data (106), during a runtime of the secured software application (108), to generate (213), for each of the sets of source instructions (102), a respective plurality of generations of a respective set of runtime instructions. Each generation of the respective set of runtime instructions is functionally equivalent to the respective set of source instructions and at least two of the generations of the respective set of runtime instructions differ from each other.

### BACKGROUND OF THE INVENTION

This invention relates to systems and methods for protecting software.

It can be useful to protect software code, such as computer games, from analysis, e.g. to prevent unauthorised copying of the code, or to prevent the code being used for malicious exploits. Traditional code protection techniques rely on applying various layers of obfuscation to the static code. Typically, these are techniques such as string encryption, identifier renaming, junk code insertion, opaque predicates and other control flow hiding techniques. These obfuscation techniques may be layered with runtime application self-protection (RASP) controls, often called ‘guards’, such as anti-debug and integrity controls like check-summing.

Whilst these techniques have proven effective, they are now well understood in the security community and are frequently overcome by attackers. Some conventional techniques also impose a substantial performance penalty and/or a risk to program integrity and so often have to be used sparingly, thereby reducing their effectiveness.

A more advanced technique which has been employed (e.g. for anti-piracy protection) is virtual machine obfuscation (VMO), in which portions of code are transformed into a virtual instruction set executed by a runtime interpreter. This achieves a high obfuscation level, because nothing remains of the original code, but it comes at a high performance cost, and so is not suitable for applying to the entirety of a processor-intensive application such as a computer game.

Embodiments of the present invention seek to provide an improved approach for protecting software.

### SUMMARY OF THE INVENTION

From a first aspect, the invention provides a computer-implemented method for generating a secured software application from a source software application, the method comprising:
receiving a source software application;
identifying one or more sets of source instructions within the source software application;
for each of the sets of source instructions, generating respective data representative of the respective set of source instructions; and generating a secured software application comprising the data and comprising a runtime engine,
   wherein the runtime engine comprises code for processing the data, during a runtime of the secured software application, to generate, for each of the sets of source instructions, a respective plurality of generations of a respective set of runtime instructions, for execution during the runtime, wherein each generation of the respective set of runtime instructions is functionally equivalent to the respective set of source instructions, but wherein at least two of the generations of the respective set of runtime instructions differ from each other.

From a further aspect, the invention provides a software tool for generating a secured software application from a source software application, the software tool comprising instructions for:
receiving a source software application;
identifying one or more sets of source instructions within the source software application;
for each of the sets of source instructions, generating respective data representative of the respective set of source instructions; and
generating a secured software application comprising the data and comprising a runtime engine,
   wherein the runtime engine comprises code for processing the data, during a runtime of the secured software application, to generate, for each of the sets of source instructions, a respective plurality of generations of a respective set of runtime instructions, for execution during the runtime, wherein each generation of the respective set of runtime instructions is functionally equivalent to the respective set of source instructions, but wherein at least two of the generations of the respective set of runtime instructions differ from each other.

From a further aspect, the invention provides a processing system for generating a secured software application from a source software application, the processing system comprising a memory and one or more processors, wherein the memory stores software which, when executed by the one or more processors, causes the processing system to:
access a source software application;
identify one or more sets of source instructions within the source software application;
for each of the sets of source instructions, generate data representative of the respective set of source instructions; and
generate a secured software application comprising the data and comprising a runtime engine,
   wherein the runtime engine comprises code for processing the data, during a runtime of the secured software application, to generate, for each of the sets of source instructions, a respective plurality of generations of a respective set of runtime instructions, for execution during the runtime, wherein each generation of the respective set of runtime instructions is functionally equivalent to the respective set of source instructions, but wherein at least two of the generations of the respective set of runtime instructions differ from each other.

From a further aspect the invention provides a secured software application comprising data and comprising a runtime engine, wherein the runtime engine comprises code for processing the data, during a runtime of the secured software application, to generate a respective plurality of generations of each of one or more sets of runtime instructions, for execution during the runtime, wherein, for each of the sets of runtime instructions, the plurality of generations of the respective set of runtime instructions are functionally equivalent, but at least two of the generations of the respective set of runtime instructions differ from each other.

From a further aspect, the invention provides a method of executing a secured software application on a processing system, wherein the secured software application comprises data and comprises a runtime engine, the method comprising the processing system using the runtime engine to process the data, during a runtime of the secured software application, to generate a respective plurality of generations of each of one or more sets of runtime instructions, for execution during the runtime, wherein, for each of the sets of runtime instructions, the plurality of generations of the respective set of runtime instructions are functionally equivalent, but at least two of the generations of the respective set of runtime instructions differ from each other.

Further aspects provide transitory media (e.g., radio signals) and non-transitory media (e.g., magnetic or semiconductor memories) storing a software tool or a secured software application as disclosed herein.

Thus it will be seen that, in accordance with embodiments of the invention, a software application can be protected from runtime attacks by generating a secured version of the software application that can generate multiple, functionally-equivalent variants of sets of instructions at runtime. This regeneration, with variation, of instructions executed at runtime can prevent an attacker from being able to place persistent break points, hooks or patched code, at runtime, because any such insertions will not be present in the next generation when the relevant set of instructions is next regenerated. Because the exact instructions that are generated varies over time, an attacker cannot simply monitor the memory for a particular sequence of instructions, and reapply the patch whenever the same sequence is detected. Thus regenerating the code with variation, within one execution of the software application, makes it very difficult to implement successful runtime attacks.

In preferred embodiments, the runtime engine comprises code for writing the runtime instructions generated by the runtime engine at each generation to a memory of a processing system executing the secured software application, and for causing the generated runtime instructions to be executed directly from the memory.

Thus each generation of runtime instructions may be generated afresh in the memory of the device while the secured software application executes. Differences between the generations of runtime instructions can be introduced as the runtime engine is executing, rather than being pre-generated and stored in memory in advance of runtime. This has security benefits over pre-generating different versions of the same executable code before runtime of the executable code, which would be more vulnerable to an attacker patching the pre-generated code, or placing breakpoints in the code, prior to runtime.

In preferred embodiments, the data representative of the sets of source instructions is also obfuscated. This can help protect the software application against static analysis. Thus the data is preferably obfuscated data, and the software application preferably comprises code for deobfuscating the obfuscated data. The obfuscation may comprise cryptographic encryption and/or any other obfuscation mechanism. In some embodiments, the data is encrypted data.

The secured software application may encode one or more cryptographic keys for decrypting the encrypted data. In some embodiments, the data comprises a plurality of data blocks, each of which is encrypted with a different encryption key. Each encrypted data block may correspond to a different set of the sets of source instructions, although this is not necessarily the case in all embodiments. The data may comprise a first encrypted data block which, when decrypted using a first cryptographic key, comprises instructions for generating a second cryptographic key (different from the first cryptographic key) for decrypting a second encrypted data block. In this way, an attacker cannot determine all of the cryptographic keys necessary for decrypting all of the data using only static analysis, since one or more of the keys is generated only during runtime of the software application. This can make it harder for an attacker to analyse the secured software application.

These methods could be applied to only a single set of runtime instructions of the source application. However, in preferred embodiments, the one or more sets of source instructions comprises a plurality of sets of runtime instructions. In some embodiments, every instruction of the source software application is included in at least one of the identified sets of source instructions. In this way, an entire application may be protected, and not only selected portions. Some sets of runtime instructions may be larger than others. This can allow a time-critical set of instructions, such as a central game loop of a game application, to be efficiently generated altogether as a single set of instructions.

The source software application is preferably received as a binary application (i.e. after compilation). This allows the protection to be conveniently applied at a late stage in production. The source instructions may be in an intermediate representation, such as Java bytecode or LLVM, or they may be executable instructions (i.e. native instructions).

The runtime instructions generated by the runtime engine are preferably native instructions (i.e. for direct execution by a processor of a target platform). As noted above, the runtime engine preferably writes the runtime instructions to the memory of the processing system executing the secured software application and causes the runtime instructions to be executed directly from the memory.

The sets of runtime instructions preferably comprise a plurality of runtime instructions. At least some of the sets may comprise a large number runtime instructions (e.g. ten or a hundred or more). In this way, the performance of the software application can be substantially better than that of a VM that interprets individual instructions one by one at runtime.

In some embodiments, each of the identified sets of source instructions is a different code block or a different function of the source software application. Thus each set of runtime instructions also corresponds to a different respective block or function.

The runtime engine may be arranged to generate the runtime instructions such that a call from a set of runtime instructions is received by the runtime engine. The runtime engine may comprise instructions for redirecting the call to a further set of runtime instructions. It may generate or regenerate the further set of runtime instructions before redirecting the call, if a generation of the further set of runtime instructions is not already in a memory of a processing system executing the secured software application.

The runtime engine may comprise instructions for removing a latest generation of a set of runtime instructions from a memory of a processing system executing the secured software application when an expiry condition is met. The expiry condition may be time dependent—e.g. after a predetermined period has expired since the latest generation was generated and/or executed.

The runtime engine comprises code for creating a new generation of a set of runtime instructions whenever a respective regeneration condition for the set of runtime instructions is met. Different sets of runtime instructions may have different regeneration conditions. Each regeneration condition may be time dependent. It may be such that the respective set of runtime instructions is regenerated when a predetermined time interval has elapsed since an immediately preceding generation. It may be such that the respective set of runtime instructions is regenerated after a predetermined number of executions of the runtime instructions. It may be a combination (e.g. the sooner) of these conditions. For example, in some embodiments, each set of runtime instructions may be regenerated at least every one or ten seconds. The regeneration condition for each set of instructions may be tunable. It may be vary between the sets of source instructions. For example, a central game loop of a computer game may be regenerated only after many invocations, so as not to impact performance unduly, while code that is run infrequently, such as copy-protection code, may be regenerated after every invocation.

The runtime engine may be arranged to clear one generation of a set of runtime instructions from a memory of a processing system executing the secured software application when generating a next generation of the set of runtime instructions. However, in some embodiments, the runtime engine may create a next generation of a set of runtime instructions before clearing a preceding generation from the memory, i.e. such that two generations exist in the memory simultaneously. This can allow it to prepare a next generation while the current generation is still available for execution, therefore preventing stalls.

The runtime engine may perform predictive generation. It may process data representative of a call graph for the source software application (which may be stored as data in the secured application) to determine when to generate a new generation of a set of runtime instructions. It may create a generation of a first set of runtime instructions in response to determining that a second set of runtime instructions is executing—e.g. a second set of runtime instructions that corresponds to a set of source instructions that contains a call to source instructions corresponding to the first set of runtime instructions. This can also prevent stalls.

The runtime engine is preferably configured such that, for every set of runtime instructions, each successive generation of a set of runtime instructions is different from an immediately preceding generation. The runtime engine may use entropy data (e.g. one or more true- or pseudo-random values) for determining one or more differences to introduce, over a preceding generation, when generating a set of runtime instructions.

The runtime engine may introduce differences between generations of a set of runtime instructions in any of various ways. In some embodiments, two generations may differ in how each generation uses memory (e.g. in the identity of a register or RAM address), or in the order of the instructions, or in the number of instructions, or in the identity of one or more instructions, or any combination of these. For example, one generation may have a different allocation of one or more registers to a preceding generation. One generation may have a different instruction order to a preceding generation (albeit while maintaining functional equivalence). One generation may comprise two or more instructions where a preceding generation has a single instruction. One generation may comprise one instruction where a preceding generation had a different instruction—for example, a move instruction in one generation may be substituted with a calculation instruction (e.g. a null calculation such as addition by zero) in another generation.

In some embodiments, the secured software application comprises one or more templates. Each template may provide a prototype from which a set of runtime instructions can be generated, with variation. The runtime engine may comprise code for resolving one or more of the templates when writing the runtime instructions to a memory of the processing system executing the secured software application. At least some of the generated runtime instructions may comprise one or more resolved templates.

The templates are preferably such that they cannot be executed until they are resolved. Thus, dynamic analysis of the templates is not possible and breakpoints cannot be inserted by malicious attackers into the templates, thus improving the security of the secured software application.

Resolving a template may be understood to mean transforming the template into executable code, e.g. by fixing one or more parameters of the template.

In some embodiments, at least a first template comprises one or more unallocated elements. The secured software application may comprise instructions for resolving the first template by allocating a respective value to each of the unallocated elements. At least one of the unallocated elements is suitable for receiving a register address, a memory address, or a constant.

A template may comprise one or more placeholders for values that are set by the runtime engine during runtime. They may be set to different values between successive generations of a set of runtime instructions. The runtime engine may allocate a respective value to one or more unallocated elements when writing runtime instructions generated by the runtime engine at each generation to the memory of the processing system executing the secured software application. The runtime engine may use a random number generator to generate a value to allocate to a respective one or more unallocated elements. For instance, it may use the random number generator to generate a pseudo-random sequence during an initialisation process, and then use this sequence for allocating values. The use of such a sequence can avoid revealing information about the function of the code, by avoiding calling a random generator of the system while executing the runtime instructions.

In some embodiments, a template may comprise data for instructing the runtime engine how to replace a first “input” sequence of one or more instructions with a second “output” sequence of one or more instructions that are functionally equivalent the first set. It may comprise data representing an input sequence and one or more functionally-equivalent output sequences. The runtime engine may use the template to substitute one of the output sequences in place of the input sequence when generating one or more generations of a set of runtime instructions.

Therefore, in some embodiments, the secured software application comprises a template comprising an input sequence and a plurality of functionally equivalent output sequences, wherein the output sequences are different to the input sequence. If an instruction or set of instructions in the source instructions or in a first generation of the runtime instructions corresponds to (e.g. contains) the input sequence, the runtime engine may use the template to write one of the output sequence to the memory when generating a next generation of the runtime instructions. This correspondence may be determined using mappings between the source instructions and the templates associated with those instructions. Such mappings may be stored in the native code generator for use at runtime.

The runtime engine may use a random number generator to select whether to use such a template and/or to select between a plurality of output sequences when generating a respective generation of a set of the runtime instructions.

In some embodiments, the data in the secured software application, representative of each set of source instructions, is an encrypted copy of the set of source instructions. The runtime engine may then generate each generation of the corresponding runtime instructions by decrypting this copy of the source instructions, and, for at least one or more of the generations, introducing one or more modifications to the decrypted set of source instructions (e.g. as disclosed above).

However, in other embodiments, the data in the secured software application may represent the source instructions using virtual machine instructions. Each virtual machine instruction may represent one or a plurality of source instructions. The runtime engine may comprise code implementing a virtual machine for interpreting the virtual machine instructions. It may use the virtual machine to create each generation of a set of runtime instructions. The virtual machine may introduce differences between successive generations of a set of runtime instructions. Methods of generating the secured software application may comprise identifying one of more fragments of source instructions that appear multiple times in the source software application, and allocating a virtual machine instruction to the fragment of source instructions. They may comprise providing code for interpreting the allocated virtual machine instruction within the runtime engine.

When generating the secured software application, the sets of source instructions may be identified automatically (e.g. by automatically parsing the source application to identify different functions), or they may be specified by a human user (e.g. in configuration data). Identifying the sets may use symbols (e.g. function names) in the source application.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram of a conventional smartphone suitable for executing software embodying the invention;

FIG. 2 is a block diagram illustrating how a secured software application is generated in accordance with embodiments of the invention; and

FIG. 3 is a block diagram illustrating how the secured software application is executed in runtime in accordance with embodiments of the invention.

### DETAILED DESCRIPTION

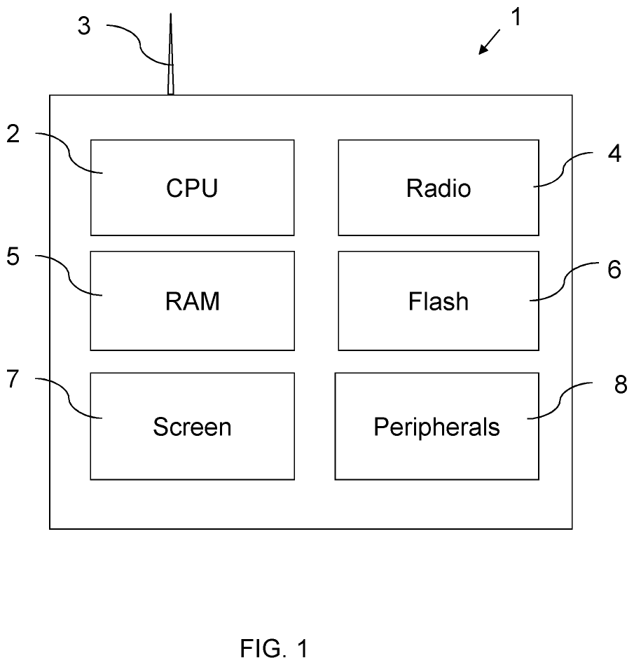

FIG. 1 shows a conventional smartphone device 1 suitable for executing software embodying the invention. It has a radio 2 and antenna 3 for communicating with a mobile telecommunications network and/or a local radio network (e.g., a WiFi 20 network). A central processing unit (CPU) 4 executes software from RAM 5 and/or flash memory 6. The smartphone 1 has a screen 7 and other peripherals 8 which may provide user interfaces, timers, I/O, hardware acceleration, and other hardware operations.

This is just one example of hardware for executing software applications embodying the invention. The invention may be implemented on embedded devices and microcontrollers (e.g., in an Internet of Things sensor), personal computers, laptops, industrial machinery, on any other suitable device or system.

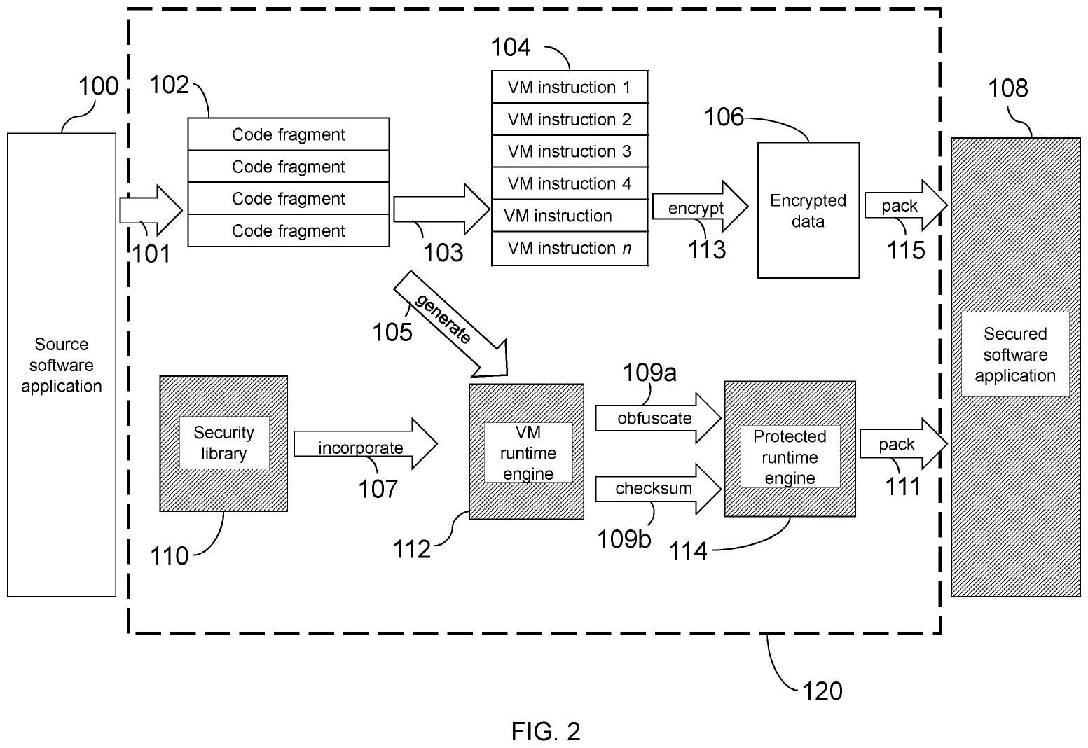

FIG. 2 is a block diagram illustrating how a secured software application (i.e. an application that has more protection against malicious attacks) is generated from a source software application, within a software tool 120 embodying the invention.

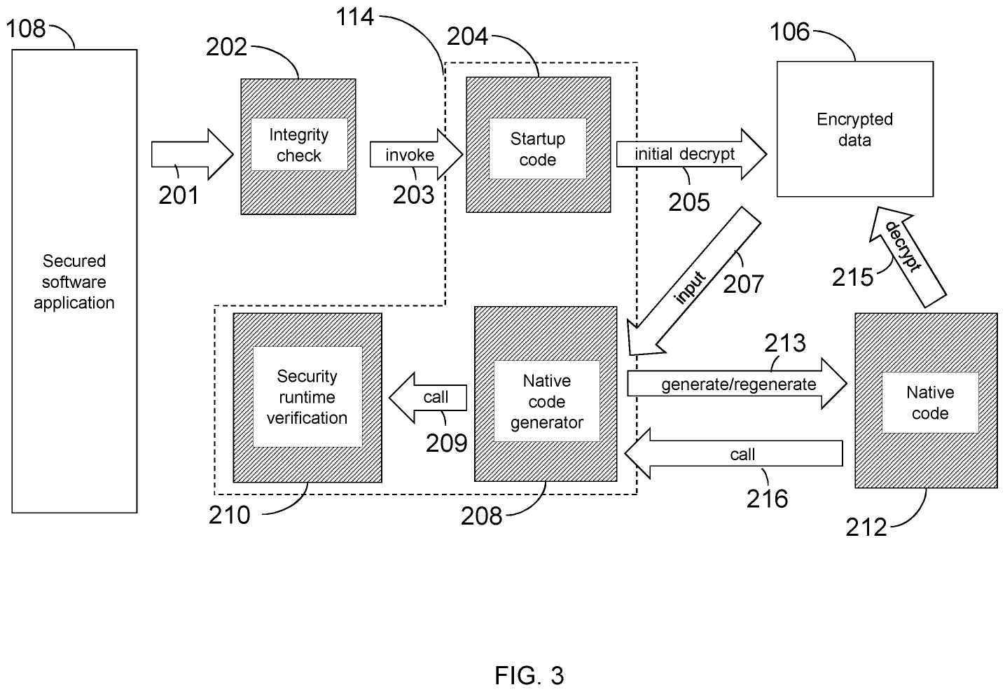

FIG. 3 is a block diagram illustrating how the resulting secured software application 108 executes at runtime on a target platform, such as the smartphone 1.

Method steps are represented by arrows in the block diagrams of FIGS. 2 and 3. Code-based entities are represented by shaded rectangles, while data is represented by unshaded rectangles. The process of the generation and execution of the secured software application according to some embodiments will now be described with reference to FIGS. 1-3.

In some embodiments, securing the software application involves a form of virtual machine obfuscation (VMO). This could be applied to only part of the application, but in some embodiments it is applied across the entire application. This achieves a much higher obfuscation level because nothing remains of the original code. However, conventional VMO methods have a high performance overhead and so typically are not used to protect entire applications.

By contrast, the present methods can use an efficient form of VMO to protect the entire source software application (e.g. a mobile game app for the smartphone 1), in which transient runtime instructions, representing sets of instructions from the source application (e.g. complete functions), are generated at the point, or shortly before, they are needed for execution. To protect the runtime instructions from being dynamically analysed or patched (e.g. to protect cheats from being introduced into a mobile gaming app), the runtime instructions are regenerated with variation at intervals during the runtime of the secured application. In this way, successive generations of each set of runtime instructions have different characteristics but are functionally equivalent to the original set of source instructions from the source application. The following description explains, in more details, how this may be achieved.

FIG. 2 shows how a secured software application 108 is generated from a binary code source software application 100—e.g. a gaming application, or any executable or library. As the source application 100 is binary (i.e. compiled), rather than source code, these methods are not limited to a certain programming language, and can be applied conveniently at a late stage in production. Generally, a software tool 120 embodying the invention may be executed on any suitable platform (e.g. a workstation) and may operate directly on binary executables and libraries 100 thereby avoiding the integration and support difficulties of being embedded in a pre-compilation toolchain.

The source software application 100 may be compiled for any executable platform, such as Apple iOS, Microsoft Windows, Android, Linux, etc. It may be in any executable format, such as Mach-O, ELF, portable executable (PE), and may include any type of executable instructions, such as ARM64 instruction set, Intel X64 instruction set or LLVM bitcode. The source software application 100 typically includes a binary header, such as a Mach-O Header, ELF Header, or PE Header.

The source software application 100 is received into the software tool 120 and the binary header is parsed to identify and extract code segments (step 101). Data segments are also extracted and processed separately from the code. Data may be optionally protected through encryption or obfuscation. The extracted code is searched to find fragments of code 102 that occur, similarly, at multiple points within the application code, such that each code fragment 102 can efficiently be represented by a single respective virtual machine (VM) instruction. Each code fragment may comprise e.g. two to five instructions or may be an entire block or function (e.g. a game loop).

In the example shown in FIG. 1, each of the fragments of source instructions 102 is allocated a corresponding virtual machine (VM) instruction and the whole source application 100 code is represented in the language of these VM instructions 104 (step 103). In particular, the original program flow is represented in the VM instructions 104 such that the functionality of the source software application 100 is not altered by this VM obfuscation of the code. The VM runtime engine 112 includes code for implementing a corresponding native code generator 208 (shown in FIG. 3 and described below) for generating native executable code from these VM instructions 104. Integrity controls may also be embedded within the VM instructions 104, as described below.

The fragments of source instructions 102 are also processed to generate a VM runtime engine 112 (step 105), capable of generating native code for each of the VM instructions 104 when the secured application 108 is executed. A security library is also incorporated 107 into the VM runtime engine 112 for performing security checks at runtime. This runtime engine 112 is obfuscated (step 109a) using traditional static obfuscation techniques—e.g. control flow obfuscation or data encryption—and checksums are embedded (step 109b), in order to generate a protected version of the runtime engine 114.

Although not represented in FIG. 2, data segments of the source application 100 are also analysed, and static strings and numeric values are identified and protected (e.g. encrypted), for inclusion in the secured application 108 as encrypted data 106. VM logic is also embedded within the runtime engine of the secured application 108 to decrypt the strings as part of the code generation when the application 108 is executed.

The VM instruction representation 104 of the code of the source application 100 is encrypted (step 113), so as to be protected from static and dynamic analysers. The VM code 104 is progressively encrypted in blocks using successive keys from a sequence of cryptographic keys, with instructions for recreating each decryption key being embedded in a preceding block. This progressive encryption provides further protection for the secured software application 108 against static analysis. The encrypted VM instructions 106 are packed into the secured software application 108 that is being generated by the software tool 120 (step 115), along with the protected VM runtime engine code 114 (step 111). The secured software application 108 thus contains obfuscated (e.g. encrypted) data segments, encrypted VM instructions, and an executable runtime engine.

Turning to FIG. 3, the execution of the secured software application, and especially the variation introduced between successive generations of native code, will now be explained.

The secured software application 108 is stored in the memory (e.g. Flash 6 or RAM 5) of the smartphone device 1. The CPU 2 can then access and run the secured software application 108. When the protected executable code 114 (i.e. the runtime engine) of the secured application 108 starts up (step 201), integrity check code 202 performs some initial integrity checks, e.g. using the checksums that were embedded within the protected code 114. It then invokes (step 203) startup code 204, contained within the runtime engine 114, for booting the native code generator 208 of the runtime engine 114 and is capable of interpreting the protected VM instructions 104.

As the VM instructions are encrypted within the encrypted data 106 of the secured application 108, an initial bootstrap cryptographic key, which is embedded in the runtime code 114, is used to decrypt the initial start-up code 204 to allow the interpreter 208 of the VM runtime engine 114 to start. Since the VM code is progressively encrypted using a succession of keys derived by the executing VM instructions, subsequent keys cannot be obtained until the target code (with embedded protections) is executing. During runtime, encrypted VM instructions 106 are received by the native code generator 208 and decrypted, using successive decryption keys (steps 205, 215), for generating corresponding native runtime instructions 212 (step 213).

More specifically, the startup process 204 starts a background generator thread which decrypts and interprets blocks of VM instructions and generates native code 212 implementing the instructions. This background thread may operate as a loop in which a block of generated native code 212 causes the decrypting 215 (by the code generator 208) of a successive block of encrypted VM instructions retrieved from the encrypted data 106. The encrypted VM instructions are input (step 207) to the native code generator 208, which decrypts and interprets them and generates 213 a next block of native code 212. Therefore, at any one time, only a small fraction of native runtime instructions corresponding to the original source application 100 are visible in RAM 5. This continual code regeneration reduces the risk of a successful attack based on an attacker patching code in the RAM 5, as the set of runtime instructions can shortly be regenerated, thereby undoing the patching.

Runtime verification may be performed by the runtime engine 114, by extracting and analysing information during runtime. Specific runtime verification code 210 may be called 209 by the code generator 208, during runtime, for verifying the integrity of other generated native code and also of the runtime engine 114 itself. At runtime, the security runtime verification code 210 will provide verification of the runtime environment. Calls to this and additional checks are embedded at protection time into the VM instructions 104. This means that if someone were to disable checks in the engine itself, new code could be generated to reinforce these checks. This code may be dynamic and not previously seen.

The integrity check code 202 performs an initial integrity check on the runtime engine 114 before execution starts. The security runtime verification code 210 performs ongoing checks during execution; this may include environmental checks such as checking if the device is rooted, if debuggers are attached, if hooking frameworks are present as well as repeating integrity checks, etc.

The native code runtime instructions 212 generated by the runtime engine 114 are functionally equivalent to the original instructions of the source application 100. Step 213 represents the generation, and subsequent regeneration, of sets of native code runtime instructions. The runtime engine 114 may process a group of VM instructions at a time, to generate a corresponding set of native instructions 212. The granularity of these sets of instructions may be set according to security policy, but may, in some embodiments, correspond to individual program blocks or functions. Variation is introduced to the generation process, by the native code generator 208, so that successive generations of the generated native code 212 differ in one or more respects. Examples of possible variation are given below. Although the native processor instructions change between generations, their functionality remains the same, and equivalent to that of the corresponding source application instructions. This regeneration process can occur many times during runtime for any given block of instructions. Depending on how the VM runtime engine is designed, some sets of instructions may be regenerated (and varied) with more or less frequency than others—i.e. there may be less or more time between successive generations. Regeneration may be at least partly time-dependent. It may additionally occur in response to execution reaching certain points in the code. There is customisability in this, which allows the performance of the secured software application to be tuneable (i.e. the performance overhead may be reduced for resource-constrained devices 1). For instance, the frequency of the new instances of successive generations of runtime instructions can be chosen with an aim to execute the secured application 108 within a predetermined maximum performance overhead compared with the source software application 100.

Furthermore, how the source software application 100 is split into sets of instructions and the size of those sets of instructions may be customisable. However, this becomes fixed during the initial protection process shown in FIG. 2. For example, the source instructions could be regenerated at the function level or at the block level. For example, if the source software application 100 is a mobile gaming application, a game loop may be generated as one block and may be regenerated (with variation) at the end of every game loop.

Important to the self-protection and self-repair of the runtime instructions 212 is the variety introduced between generations. For example, subsequent generations may use different register allocations, and/or the order of instructions may be slightly different (as long as functionality is preserved), and/or protection code embedded within the generative native code 212 may be varied or sometimes included and sometimes absent. This change in structure prevents malicious observers, who are seeking to patch the native code, from easily reapplying a patch every time the code is regenerated, since it may look different every time.

To avoid stalls, some embodiments employ predictive generation of the native runtime instructions 212. This allows the runtime engine 114 to speculatively generate code 212 that is expected to be called imminently, before it is actually called. For example, predictions can be made by knowing what function is currently being executed at runtime and knowing what functions are called by the currently executing function. Predictions may made using data describing the functions within the secured application 108 (corresponding to functions within the source application 100). This data may comprise a call graph, created at protection time (i.e. during the process shown in FIG. 2). Furthermore, predictive behaviour may depend on how often a code block is executed at runtime, e.g. with commonly invoked functions being more aggressively predicted.

At the start of runtime of the secured application 108, once an initial set of native code runtime instructions 212 have been generated, the startup process 204 invokes it directly as a set of native instructions, thereby avoiding the performance overhead of instruction-by-instruction VM interpretation. Meanwhile, the generator 208 finds subsequent program blocks (or functions) via VM function call instructions and proceeds to generate those.

When the executing native code 212 reaches a function call, it calls 216 back into the engine 114 to find the location of the called function. Because subsequent instructions are generated pre-emptively, the called function should already be generated. This means a simple look-up and indirect call can occur. If the function does not yet exist in native code 212, then the program is stalled and has to wait until the generator 208 generates this code.

Advantageously, the VM runtime engine 114 keeps track of when code is ‘hot’ i.e. executed frequently, and when it becomes ‘cool’, i.e. not used frequently. This may be used to change the frequency of regeneration of the sets of instructions—e.g. with cool code being regenerated after every one or two invocations, whereas hot code might only be regenerated every few hundred or thousand invocations. This may help to minimise stalls. When code becomes cool, it is aged and pruned from memory 5. This may happen if the function is not called for a certain threshold period of time. However, if program execution comes back to this code, it can be regenerated with variation. Periodically, even hot code is regenerated with variation.

Embedded within the native code 212 is additional code to derive keys to decrypt 215 further code blocks and functions. These are lodged with the native code generator 208 which uses the keys to decrypt later functions as it encounters them. (The “decrypt” arrows 205, 215 in FIG. 3 should be understood as figurative, since the actual decryption operation is performed within the native code generator 208, on encrypted data fetched 207 from the encrypted data 106.) The progressive decryption and generation ensures that the whole program cannot be analysed at any one time.

In fact, static analysis is impossible because all of the code derived from the source application 100 is encrypted at rest. Analysis can only commence once execution is underway and then only for the currently executing set of runtime instructions 212. Further sets of runtime instructions cannot be observed or executed until they are generated and they can only be decrypted once the key derivation for that set of instructions (e.g. implementing a particular function) has been reached. This means that attempting to vary the control flow or execute code out of sequence will fail since the keys will not be available.

In one example, the source software application 100 may be a mobile gaming app for execution on the smartphone 1. Typically gaming apps lack proper security, which allow tamperers to cheat, steal sensitive app data, or steal revenue. The secured software 108 generated from the unsecured source application 100 can provide security against game cheats by being self-protecting and self-repairing, thus preventing attackers from patching and dynamically analysing the code to reverse engineer it. Protecting against cheats can help gaming companies to protect brand reputation, and prevent revenue loss. Furthermore, a gaming app may provide in-game currency or wallets. Therefore, the present methods may also help to prevent theft of currency and other sensitive app data.

Embodiments of the software tool and method discloses herein provide a number of security benefits. Firstly, the code has strong VMO style obfuscation with reduced performance overhead. Attacks attempting to patch code are defended against as the code is frequently regenerated and therefore auto-repaired. Dynamic analysis is extremely difficult because only small sections of the code are revealed at a time, thus providing an attacker with a constantly moving target. All calls are routed through the VM runtime engine 114 and so an attacker would find it very difficult to build a call graph or understand the control flow.

Debugging is very difficult because the native executable code 212 is ephemeral so breakpoints are lost and the stack trace is obscured by the VM runtime engine 114. The transient nature of the code and regeneration with variation may remove the need to embed costly and visible ‘guards’.

The runtime engine 114 may optionally use traditional static techniques to help protect itself, but the regenerated instructions can generate further protection code interspersed within the generated target runtime instructions 212. This code can verify the integrity of the target code and also the runtime engine 114 itself.

Some embodiments can also beneficially result in significant compression of the distributable code.

There are many ways in which variation may be introduced into the generated sets of native instructions between generations. Though not an exhaustive list, potential approaches for introducing variation are described below and examples in assembly language are shown for illustrative purposes

### First Example—Register Allocations

A compiler will traditionally allocate registers at build time. However, since code is here generated at runtime, registers can be allocated arbitrarily and varied between successive generations of runtime instructions. Thus, regenerating the set of runtime instructions may include changing the allocation of one or more registers.

In the table below, variation is introduced between a first generation and a second generation by multiplying the values of two registers in a different order and storing the result in a different register. It shows an instruction “mul” which multiplies the values from each of the second and third register, and places the least significant 32 bits of the result in the first register. The instruction “mul x11, x11, x12” may be changed to “mul x12, x12, x11”. In “mul x11, x11, x12”, register “x11” and “x12” are multiplied and the result is written to register “x11”, while in “mul x12, x12, x11”, register “x12” and “x11” are multiplied and the result is written to register “x12”.

| Generation 1 | Generation 2 |
|---|---|
| movz x12, #0x8 | movz x11, #0x8 |
| mul x11, x11, x12 | mul x12, x12, x11 |
| adrp x10, #0x12000 | adrp x9, #0x12000 |
| add x10, x10, x11 | add x9, x9, x12 |
| ldr x10, [x10, #0x60] | ldr x9, [x9, #0x60] |

This variation does not affect the overall functionality of the code. However, this variation can prevent an attacker from tracking and patching the code. Registers used for the calculation may be varied so that the instruction encoding is different each time.

### Second Example—Instruction Sequencing

Regenerating the set of runtime instructions may include, for instructions whose functionality do not depend on their order, changing the order of one or more of the instructions in the set of runtime instructions.

This can be done without changing the functionality of the code so long as dependencies are respected. Therefore, two instructions that are mutually independent may be switched around or reordered as long as their order does not make a functional difference to the remaining instructions.

The table below provides an example in which the “adrp” instruction on “x10”, in a first generation, has been moved to be before the multiplication in a second generation. Both are needed for the later “add” but the order does not matter before that.

| Generation 1 | Generation 2 |
|---|---|
| movz x12, #0x8 | adrp x10, #0x12000 |
| mul x11, x11, x12 | movz x12, #0x8 |
| adrp x10, #0x12000 | mul x11, x11, ×12 |
| add x10, x10, x11 | add x10, x10, x11 |
| ldr x10, [x10, #0x60] | ldr x10, [x10, #0x60] |

### Third Example—Register to Stack

In some embodiments, regenerating a set of runtime instructions may involve changing a first instruction in one generation into a plurality of second instructions, which have the same function as the first instruction, in a second generation.

For example, the first instruction may move a value from a source register to a destination register. The plurality of second instructions may store the value of the source register on the stack and then load the value to the destination register from the stack.

This is shown in the example in the table below, which, rather than a simple move between registers in a first generation (e.g. with the instruction mov x0, x21), a second generation uses the stack instead. Values of a source register (e.g. x21) may be stored on the stack and then loaded to the destination register (e.g. x0), e.g. by the instructions str x21, [29, #-16] followed by Idr x0, [29, #-16].

The same approach can be used for calculations and many other manipulations. However, it executes slower, since it requires more instructions and memory accesses, and so may be used relatively sparingly.

| Generation 1 | Generation 2 |
|---|---|
| mov x0, x21 | str x21, [29, #-16] |
| | ldr x0, [29, #-16] |

### Fourth Example—Moves to Calculations

An efficient way for the code generator 208 to introduce variation between different generations of functionally-equivalent instructions that involve a move between registers is to perform a redundant arithmetic operation.

For simple moves between registers, a variation may be to use a calculation instead by introducing a calculation instruction instead of a move instruction. In the example in the table below, adding 0 (zero) to the values in register “x21” and storing the result in register “x0” is functionally equivalent to moving the values of register “x21” to register “x0”.

| Generation 1 | Generation 2 |
|---|---|
| mov x0, x21 | add x0, x21, 0 |

These four examples illustrate some of the ways that the runtime engine 114 may introduce variety by changing memory or control-flow characteristics of the generated runtime instructions between generations. These may be used individually or in combination. However, the actual variation techniques that are implemented may be chosen depending on the capabilities of the instruction set of the target platform (e.g. of the smartphone 1) and on performance considerations.

The native code generator 208 may access a source of entropy, such as a true or pseudo-random number generator, to determine which of a set of possible variations to apply when generating any particular generation of a set of native code instructions 212.

As mentioned above, registers can be allocated arbitrarily at runtime and varied between successive generations of runtime instructions. In practice, this may be implemented in some embodiments using code templates that can be resolved during runtime. The native code generator 208 may store or access one or more templates, and process the templates during runtime to generate varying generations and for successively writing these to the RAM 5 for execution.

The native code generator 208 may store a mapping from source instructions or VM instructions to respective templates, for use at runtime.

Each template may comprise data for implementing one or more variations, for example, implementing any of the variation as described above with respect to the above examples.

In some embodiments, the secured software application comprises one or more templates, each template comprising one or more unallocated elements (e.g. register addresses, memory addresses, or constants) that are allocated (i.e. assigned values) when the runtime instructions are written by the runtime engine to the memory 5 of the processing system executing the secured software application.

Therefore, a template can be used to implement one or more variation techniques, with variation between generations being introduced by virtue of the element allocation being different between generations. As the unresolved templates cannot be executed directly, dynamic analysis of a template by an attacker is not possible and breakpoints cannot be inserted into the unresolved templates by malicious attackers.

Some templates may, instead of or as well as containing such unallocated elements, store one or more output sequences that contain variation. This can allow the order or instructions to be changed by processing such a template.

Some examples of such templates are given below in assembly language. The unallocated elements are shown in the example templates between the angle brackets (e.g. <reg>).

### Template: First Example—Register Allocations

The template example below corresponds to the ‘Register allocations’ example, i.e. the first example, shown above. Here, variation between generations is introduced by allocating different registers and/or memory addresses (e.g. in RAM 5) to a common template when regenerating a set of runtime instructions.

This template is stored as a code prototype in which the unallocated elements include a placeholder first register element <reg1>; second register element <reg2>; third register element <reg3>; and address element <addr1>.

When generating each new generation of a set of runtime instructions that is associated with this template (e.g. that contains this sequence of instructions), the native code generator 208 uses a pseudo-random sequence, based on some entropy (e.g. generated using a random number generator of the system, before starting to execute the VM instructions) to select a value for each element from a respective set of possible values, and allocates the selected values by writing the instructions with the allocated operands to the RAM 5 at runtime.

Template - Register allocations

movz <reg1>, <addr1>
mul <reg2>, <reg2>, <reg1>
adrp <reg3>, #0x12000
add <reg3>, <reg3>, <reg2>
ldr <reg3>, [<reg3>, #0x60]

### Template: Second Example—Instruction Sequencing

In some embodiments, a template may allow an instruction or a sequence of instructions to be replaced by one or more variations which are functionally equivalent.

In this example, for a given set of instructions that match the input sequence shown in the first column, the output sequence shown in the second column may sometimes be selected and executed instead of the input sequence. The native code generator 208 may randomly select whether or not to substitute the input sequence with the output sequence each time a set of runtime instructions containing instructions that match the input sequence of the template is re-generated.

In this example, the same five instructions are executed, but the order of the first three instructions is changed.

| Input sequence | Output sequence |
|---|---|
| movz A, #0x8 | adrp C, #0x12000 |
| mul B, B, A | movz A, #0x8 |
| adrp C, #0x12000 | mul B, B, A |
| add C, C, B | add C, C, B |
| ldr C, [C, #0x60] | ldr C, [C, #0x60] |

Here, A is a first register, B is a second register and C is a third register. Optionally, and as long as the functionality of the set of instructions remains unchanged, A, B and C could be unallocated in the template, with the registers only being allocated during runtime, e.g. A=<reg1>, B=<reg2> and C=<reg3>. This would add a further layer of variation, providing more protection against dynamic and static analysis.

### Templates: Third/Fourth Example—‘Register to Stack’ or ‘Moves to Calculations’

In some embodiments, if one instruction or sequence of instructions can be implemented in a plurality of different ways, then a template in the secured software application may stores a plurality of output sequences for a given input sequences. If an instruction or sequences of instructions generated by the native code generator 208 in one generation of a set of runtime instructions corresponds to the input sequence, then, in a subsequent generation, the native code generator 208 may randomly select one of a plurality of output sequences to write to the RAM 5 for execution instead.

In this example, the template stores two equivalent sequences to a ‘move to register’ instruction (e.g. mov x0, x21). The native code generator 208 may use this template to randomly substitute instructions matching the input sequence (i.e. mov A, B) with one or other of the output sequences (or may select not to apply any substitution on occasions). Here, A is a first register (e.g. x0) and B is a second register (e.g. x21).

This means that either ‘Output sequence 1’ or ‘Output sequence 2’ can be selected, written to the RAM 5 and executed.

| Input sequence | Output sequence 1 | Output sequence 2 |
|---|---|---|
| mov A, B | str B, [SP, #-16] | add A, B, 0 |
| | ldr A, [SP, #-16] | |

“SP” here refers to the stack pointer, although this is just indicative, as some further instructions may be required the system does not permit the stack pointer to be used directly.

Some further examples of unresolved templates are given below. The following example templates all relate to an intermediate jump between two code modules, i.e. a ‘trampoline’.

### First Example—Direct Jump

In some embodiments, a template may comprise just one unallocated value. For example, the template according to this first example comprises code for a branch-link operation, i.e. a direct jump, with one unallocated destination address.

This is shown in the example in the table below, which is a code snippet for branching to a destination address (i.e. <destination>) that is unallocated when the code is at rest and is only allocated at runtime, when the code is being executed. When the resulting code is executed, the link register is loaded with the address of the instruction that comes next in memory, which allows the code to return from the branch using the link register.

Template - Direct jump

bl <destination>

### Second Example—Jump Via a Register

In some embodiments, a template may comprise more than one unallocated value. The unallocated value may be a register or a destination memory address.

This is shown in the example template below, in which a code snippet for a code jump via a register has an unallocated register (<reg>) and an unallocated destination address (<destination>). The destination address is the address of the target module which has the instruction that is to be executed next.

According to this second example, when the values are allocated and the resulting code is executed, the register <reg> is pushed onto the stack. The instruction at the chosen destination address is loaded into the allocated register. Using the ‘bl’ instruction, the execution directly jumps to the register <reg>.

Template - Jump via a register

push {<reg>}
ldr <reg>, <destination>
bl <reg>

### Third Example—Return Oriented Jump

Below is an example of a return oriented jump. An unallocated register <reg> appears twice in the same template, and is allocated the same randomly-chosen value at each instance. The program counter (pc) contains the memory address of the next instruction.

In this example, a register is allocated to <reg>, and, when the resulting code is executed, that register is pushed onto the stack and an instruction after the next instruction (located at pc+8) is loaded into that register. Then, <reg> is pushed onto the stack before the return instruction (ret) returns from the subroutine.

Template - Return oriented jump

push {<reg>}
ldr {<reg>}, pc + 8
push {<reg>}
ret

### Fourth Example—Calculated Address Jump

Below is an example of a calculated address jump. An unallocated register <reg> appears five times in the same template alongside other unallocated elements. For instance, <masked_destination> is a hidden address of a target module and <mask> is a hiding constant value.

In this example, once the template is resolved and the resulting code is executed, the register <reg> is pushed onto the stack, the value at the masked destination is loaded into that register, and a bitwise XOR operation is performed on the value in the register and the hiding constant value. The result is stored in the register before a branch link instruction jumps to the register.

Template - Calculated address jump

push {<reg>}
ldr <reg>, <masked_destination>
xor <reg>, <reg>, <mask>
bl <reg>

Using any or all of the techniques described above, code may be regenerated frequently and with variation. A combination of variation approaches may be used so that successive generations of the set of runtime instructions differ in multiple characteristics.

It will be appreciated by those skilled in the art that the invention has been illustrated by describing one or more specific embodiments thereof, but is not limited to these embodiments; many variations and modifications are possible, within the scope of the accompanying claims.

1. A computer-implemented method for generating a secured software application from a source software application, the method comprising:
receiving a source software application;
identifying one or more sets of source instructions within the source software application;
for each of the sets of source instructions, generating respective data representative of the respective set of source instructions; and
generating a secured software application comprising the data and comprising a runtime engine,
wherein the runtime engine comprises code for processing the data, during a runtime of the secured software application, to generate, for each of the sets of source instructions, a respective plurality of generations of a respective set of runtime instructions, for execution during the runtime, wherein each generation of the respective set of runtime instructions is functionally equivalent to the respective set of source instructions, and wherein at least two of the generations of the respective set of runtime instructions differ from each other; and
wherein the runtime engine comprises code for writing the runtime instructions generated by the runtime engine at each generation to a memory of a processing system executing the secured software application, and for causing the generated runtime instructions to be executed directly from the memory.

2. The computer-implemented method of claim 1, wherein the data representative of the sets of source instructions is obfuscated and the secured software application comprises code for deobfuscating the data.

3. The computer-implemented method of claim 1, wherein the data representative of the sets of source instructions is encrypted and the secured software application encodes one or more cryptographic keys for decrypting the encrypted data.

4. (canceled)

5. (canceled)

6. The computer-implemented method of claim 1, wherein every instruction of the source software application is included in at least one of the identified sets of source instructions.

7. The computer-implemented method of claim 1, wherein the source software application is received as a binary application.

8. The computer-implemented method of claim 1, wherein the runtime instructions generated by the runtime engine are native instructions.

9. (canceled)

10. The computer-implemented method of claim 1, wherein the runtime engine comprises code for generating the sets of runtime instructions such that a call from a set of runtime instructions is received by the runtime engine, and further comprises code for redirecting the call to a further set of runtime instructions.

11. The computer-implemented method of claim 1, wherein the runtime instructions generated by the runtime engine are ephemeral and are transiently stored in the memory of the processing system executing the secured software application.

12. The computer-implemented method of claim 1, wherein the runtime engine comprises code for removing a latest generation of a set of runtime instructions from the memory of the processing system executing the secured software application when an expiry condition is met.

13. (canceled)

14. (canceled)

15. The computer-implemented method of claim 1, wherein the runtime engine comprises code for creating a next generation of a set of runtime instructions before clearing a preceding generation of the set of runtime instructions from the memory of the processing system executing the secured software application.

16. (canceled)

17. (canceled)

18. The computer-implemented method of claim 1, wherein the runtime engine comprises code for introducing differences between two generations of a set of runtime instructions such that each of the two generations uses memory differently, or has the same runtime instructions in a different order, or contains a different number of runtime instructions, or contains one or more different runtime instructions, or has any combination of these differences.

19. The computer-implemented method of claim 1, wherein the data in the secured software application represents the source instructions using virtual machine instructions, wherein each virtual machine instruction represent one or a plurality of source instructions, and wherein the runtime engine comprises code implementing a virtual machine for interpreting the virtual machine instructions to create the plurality of generations of each set of runtime instructions.

20. (canceled)

21. The computer-implemented method of claim 1, wherein the secured software application comprises one or more templates and wherein the runtime engine comprises code for resolving one or more of the templates when writing the runtime instructions to the memory of the processing system executing the secured software application such that at least some of the generated runtime instructions comprise one or more resolved templates.

22. The computer-implemented method of claim 21, wherein a first template of the one or more templates comprises one or more unallocated elements, and wherein the secured software application comprises code for resolving the first template by allocating a respective value to each of the unallocated elements of the first template.

23. The computer-implemented method of claim 22, wherein at least one of the unallocated elements is suitable for receiving a register address, or a memory address, or a constant.

24. (canceled)

25. (canceled)

26. The computer-implemented method of claim 24, wherein the runtime engine comprises code for creating a new generation of the set of runtime instructions when a predetermined time interval has elapsed since generating an immediately preceding generation of the set of runtime instructions; or after a predetermined number of executions of the runtime instructions.

27. The computer-implemented method of claim 1, wherein the runtime engine comprises code for:
clearing one generation of a set of runtime instructions from the memory of the processing system executing the secured software application when generating a next generation of the set of runtime instructions; or
creating a next generation of a set of runtime instructions and subsequently clearing a preceding generation from the memory, such that two generations exist in the memory simultaneously.

28. A non-transitory computer-readable medium storing instructions which, when executed on a processing system, cause the processing system to carry out a method for generating a secured software application from a source software application, the method comprising:
receiving a source software application;
identifying one or more sets of source instructions within the source software application;
for each of the sets of source instructions, generating respective data representative of the respective set of source instructions; and
generating a secured software application comprising the data and comprising a runtime engine,
wherein the runtime engine comprises code for processing the data, during a runtime of the secured software application, to generate, for each of the sets of source instructions, a respective plurality of generations of a respective set of runtime instructions, for execution during the runtime, wherein each generation of the respective set of runtime instructions is functionally equivalent to the respective set of source instructions, and wherein at least two of the generations of the respective set of runtime instructions differ from each other; and
wherein the runtime engine comprises code for writing the runtime instructions generated by the runtime engine at each generation to a memory of a processing system executing the secured software application, and for causing the generated runtime instructions to be executed directly from the memory.

29. A processing system for generating a secured software application from a source software application, the processing system comprising a memory and one or more processors, wherein the memory stores software which, when executed by the one or more processors causes the processing system to carry out a method comprising:
receiving a source software application;
identifying one or more sets of source instructions within the source software application;
for each of the sets of source instructions, generating respective data representative of the respective set of source instructions; and
generating a secured software application comprising the data and comprising a runtime engine,
wherein the runtime engine comprises code for processing the data, during a runtime of the secured software application, to generate, for each of the sets of source instructions, a respective plurality of generations of a respective set of runtime instructions, for execution during the runtime, wherein each generation of the respective set of runtime instructions is functionally equivalent to the respective set of source instructions, and wherein at least two of the generations of the respective set of runtime instructions differ from each other; and
wherein the runtime engine comprises code for writing the runtime instructions generated by the runtime engine at each generation to a memory of a processing system executing the secured software application, and for causing the generated runtime instructions to be executed directly from the memory.

30. A non-transitory computer-readable medium storing a secured software application generated by the method of claim 1.
